(19) United States
(12) Patent Application Publication
(10) Pub. No.: US 2021/0262281 A1
(43) Pub. Date: Aug. 26, 2021

(54) THERMAL BARRIER ROLLER DOOR ASSEMBLIES AND PARTS THEREOF

(71) Applicant: AUTO MOSSA HOLDINGS LIMITED, Devonport, Auckland (NZ)

(72) Inventor: Mark James BRUNTON, Devonport, Auckland (NZ)

(21) Appl. No.: 17/255,370

(22) PCT Filed: Jun. 27, 2019
(86) PCT No.: PCT/NZ2019/050077

§ 371 Date: Dec. 22, 2020

(30) Foreign Application Priority Data
Jun. 27, 2018 (NZ) 743870

(51) Int. Cl. E06B 9/15; E06B 9/17

(52) U.S. Cl. CPC E06B 9/15; E06B 9/17; E06B 2003/7044; E06B 2009/1566; E06B 2009/17069; E06B 2009/1522

(57) ABSTRACT

The construction of rapid opening thermally insulated roller doors is challenging in that there are both structural and operational challenges. The door blades need to have structural strength, and also need to have dimensional stability. Disclosed is a thermally insulated roller door blade in which at least the material forming the outer surface is able to resist the tensile loads during retraction, and the blade is provided with flexible spacer strips that help the primary insulating material of the door blade to maintain dimensional stability, primarily by helping to resist crushing. This allows softer materials to be used for thermal insulation than previously used, helping to reduce weight and to improve thermal efficiency, while at the same time allowing smooth and repeatable operation even when exposed to freezing temperatures for long periods.

### FIELD OF THE INVENTION

This invention relates to thermal barrier roller door assemblies and component parts thereof, and in particular, but not exclusively to rapid opening thermal barrier roller doors for use in the entrance doorways of cool stores or freezer compartments.

### BACKGROUND

The entrance doors to cool stores typically have some form of rapid opening door that is automatically opened when a forklift truck approaches and closes as soon as the truck has passed. Roller doors are particularly suited to this application as they do not swing outwards in either direction, and a range of rapid opening roller doors are available. A number of rapid opening roller doors include thermal insulation to minimise heat transfer into the cool stores while the doors are closed.

The blades of these roller doors are made of a number of relatively narrow panels, that is narrow in a vertical direction, with each narrow panel being joined to adjacent panels. The joints between adjacent panels often includes horizontally aligned wind bars. The wind bars help to keep the door blades flat during wind gusts and thereby help to prevent the door blades disengaging from the vertical guides at each edge of the blades.

However, these joints often present challenges, especially with thermal barrier roller doors where the thickness of the panels, the weight of the combined panels, along with the need to maintain a thermal barrier at the joints, create additional challenges.

When a rapid opening roller door begins to open, it is necessary to accelerate the entire door blade in an upward direction. This is achieved by rotating a roller drum at the top of the door which pulls the first panel of the door blade upwards, dragging all the other panels in an upward direction after it and at a reasonably high speed. During the initial acceleration of the entire door blade, significant loads are transferred between adjacent panels through the panel joints.

The panel joints typically include a bonded joint between a relatively thick and lightly constructed thermal insulation panel and some form of metal or plastics extrusion of the wind bars. The relatively thick and light thermal insulation panels are made of a material that minimises thermal transfer, for example a foamed urethane material, but while the material is a good insulator it is often relatively weak structurally, and the bonded joints to the extrusions that form the wind bars can tend to fail.

These bonded joint failures are particularly common in the upper joints where the weight of the door blade below the joint is the greatest.

The bonded joints also make panel replacement difficult, for example when replacing a single damaged insulation panel that may have been damaged by contact with a forklift or with the load carried by a forklift.

Another problem with thermally insulated doors is that the insulating material can become more rigid when exposed to the cold of a freezer environment. The stiffening of the material makes it less inclined to roll tightly or compactly about the drum when the door is rolled up. For this reason, it can be advantageous to use a thermal insulating material that is as soft and pliable as possible.

However, a problem with soft and pliable insulation is that it tends to become crushed or compacted when the door panel is rolled onto the roller drum. This causes a number of significant problems, particularly in industrial or cool-store operations, where it is not uncommon for rapid opening roller doors to operate through over a million cycles during the design life of a door. Any tendency for the insulation material to become crushed or compacted will produce significant operational problems.

Firstly, the insulating material will lose its effectiveness when it is crushed as the thickness of the insulation barrier is reduced. And secondly, the roller door blade will become dimensionally inconsistent. That is, the position of the bottom edge of the door blade, when rolled fully up, or when rolled fully down, can tend to change depending on the amount of compaction of the insulating material. When the material is crushed a little, the diameter of the rolled door decreases meaning that the door blade will not be retracted as far when the drive motor has completed its ‘up’ cycle. And if the door blade does not fully retract, the ability of the door blade to ‘self-realign’ at the top of the guides can be affected. That is, roller doors are often designed to self-realign or to re-engage with the door guides, after being fully retracted, to allow for situations where the door has been bumped and the door blade edges have slipped out of the guides. This feature may not function if the bottom of the door blade does not lift up far enough to engage the funnelling section at the top of the guides when the door blade is next lowered.

Compaction of the insulating material can also affect the full down position of the door blade, resulting in a gap at the bottom of the door if the blade doesn't reach the ground, or bulging or bagging if the blade travels too far and rests heavily on the ground.

What is needed is a design for a thermally insulated roller door that is robust, reliable and repairable, and which does not become too stiff when chilled, and which remains dimensionally stable after continued use and in a range of chilled and ambient temperatures, and which is capable of achieving these goals over a design life that may be in the order of a million cycles.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a thermal barrier roller door assembly, and/or parts for a thermal barrier roller door assembly, which will at least go some way towards overcoming one or more of the above mentioned problems, or at least provide the public with a useful choice.

### STATEMENTS OF THE INVENTION

Accordingly, in a first aspect, the invention may broadly be said to consist in a thermal door blade panel for a roller door blade, the thermal door blade panel being substantially rectangular and having an upper edge and a lower edge, the thermal door blade panel having a composite construction and being made of at least one thermal insulating member bonded to at least one tensile load carrying panel, the or each tensile load carrying panel being configured to engage with, or form a connection with, an adjacent thermal door blade panel or a joint fitting along at least the upper edge or the lower edge of the thermal door blade panel.

Preferably the or each tensile load carrying panel is made of a flexible planar sheet material.

Preferably the flexible planar sheet material is a fabric material or a coated fabric material, for example a PVC coated fabric material.

Preferably at least the upper edge or the lower edge of the or each tensile load carrying panel includes a bulbed edge, or keder style bulbed edge, configured to engage with a socket of the joint fitting.

Preferably the or each tensile load carrying panel is connected to the or each associated joint fitting using a keder style connection.

Preferably the thermal door blade panel further includes a left edge and a right edge, the left edge and the right edge both being configured to engage with, and slide up and down, a roller door blade edge guide.

Preferably the thermal insulating member is made of a foamed plastics material, for example a foamed polyurethane material.

Optionally the thermal door blade panel comprises a sandwich construction having a tensile load carrying panel on each side of the thermal insulating member.

In a second aspect, the invention may broadly be said to consist in a thermal joint fitting for a thermal roller door blade, the thermal joint fitting comprising at least two longitudinal members, and having at least one thermal break between the or each adjacent longitudinal member, the thermal break being configured to minimise heat transfer from an outer surface of the thermal roller door blade to an inner surface of the thermal roller door blade.

Preferably the thermal joint fitting is configured to engage with two thermal door blade panels substantially as specified herein.

Preferably the thermal joint fitting comprises three longitudinal members, a first longitudinal member configured to substantially align with a first face of a thermal roller door blade, a second longitudinal member configured to substantially align with a second and opposite face of the thermal roller door blade, and a third longitudinal member configured to span between the first longitudinal member and the second longitudinal member and to tie the first longitudinal member to the second longitudinal member.

Preferably at least one of the longitudinal members includes keder style sockets configured to mate with a bulbed or keder style edge on each of the thermal door blade panels.

Preferably the longitudinal members are made from a fibre reinforced composite material, for example a fibre glass material.

Preferably at least one of the longitudinal members includes a bulbed edge configured to engage longitudinally with a complimentary bulbed longitudinal socket formed within another of the longitudinal members.

In a third aspect, the invention may broadly be said to consist in a thermal roller door blade incorporating at least two thermal door blade panels substantially as specified herein.

Preferably the thermal roller door blade further includes one or more thermal joint fittings substantially as specified herein.

Preferably the or each thermal joint fitting is used to connect adjacent thermal door blade panels.

In a fourth aspect, the invention may broadly be said to consist in a thermal roller door blade, the thermal roller door blade comprising a plurality of first pockets containing a flexible thermal insulating material, the first pockets being formed between two or more layers of a flexible planar sheet material, the thermal roller door blade also having two or more spacer strips, the spacer strips each being oriented in a substantially longitudinal direction and extending from a location at or adjacent a top end of the thermal roller door blade to a location at or adjacent a bottom end of the thermal roller door blade.

Preferably the flexible planar sheet material is a fabric material or a coated fabric material, for example a PVC coated fabric material.

Preferably the first pockets are aligned in a substantially transverse direction on the thermal roller door blade.

Preferably the spacer strips are situated at or adjacent each end of each first pocket.

Preferably the spacer strips have a thickness that is substantially the same as, or thicker than, a mean thickness of the flexible thermal insulating material contained within the first pockets.

Preferably the spacer strips have a thickness that is in the range of five to fifteen percent greater than the mean thickness of the flexible thermal insulating material contained within the first pockets.

Preferably the spacer strips are made from a foamed elastomeric material, for example a foamed ethylene propylene diene monomer elastomeric material (EPDM) or similar product.

Preferably the material that forms the spacer strips has a hardness rating that is greater than a hardness rating of the flexible thermal insulating material.

Preferably the material that forms the spacer strips has a Shore C Hardness in the range of fifteen to thirty, and more preferably in the range of seventeen to twenty five.

Preferably the spacer strips are contained within second pockets of the thermal roller door blade.

Preferably the second pockets are elongate pockets aligned in the substantially longitudinal direction.

Preferably the spacer strips are covered in a low friction sleeve or the second pockets include a low friction lining material, for example a sleeve or lining made of a lycra or silk fabric.

Preferably the flexible thermal insulating material includes one or more layers of insulating material in the form of air cell insulation material.

Preferably the air cell insulation material is in the form of foil coated or foil-faced air cell insulation sheets, for example a foil coated air cell insulation material, a polyester bubble foil insulation material, or a thermal aluminium bubble foil material.

Preferably the thermal roller door blade includes an outer layer of the flexible planar sheet material and an inner layer of the flexible planar sheet material.

Preferably the thermal roller door blade includes an abutment zone between each adjacent pairing of first pockets, and the thermal roller door blade includes an intermediate strip of flexible planar sheet material that is situated at or adjacent each abutment zone.

Preferably the construction of the thermal roller door blade includes transverse lines of attachment between the outer layer of the flexible planar sheet material, the intermediate strips of the flexible planar sheet material, and the inner layer of the flexible planar sheet material.

Preferably the transverse lines of attachment each include welds.

Preferably each intermediate strip that is attached to the outer layer along a top edge of the intermediate strip and is attached to the outer layer along a bottom edge of the intermediate strip.

Preferably the inner layer is attached to each of the intermediate layer strips along a line of attachment that is situated between the top edge of the respective intermediate strip and the bottom edge of the respective intermediate strip.

Preferably each line of attachment between the inner layer and each of the intermediate strips defines the top of the first pocket that is situated directly below the respective line of attachment, and/or defines the bottom of the first pocket that is situated directly above the respective line of attachment.

Preferably the spaces formed between the outer layer and each of the intermediate strips each form a third pocket.

Preferably the flexible thermal insulating material is also contained within each of the third pockets.

Preferably the third pockets are aligned in a substantially transverse direction on the thermal roller door blade.

Preferably the third pockets overlie the abutment zones.

Optionally the thermal roller door blade further includes wind bars situated within one or more of the third pockets.

In a fifth aspect, the invention may broadly be said to consist in a thermal roller door blade, the thermal roller door blade comprising a plurality of first pockets containing a first type of flexible filler material, the first pockets being formed between two or more layers of a flexible planar sheet material, the thermal roller door blade also having two or more spacer strips, the spacer strips each being oriented in a substantially longitudinal direction and extending from a location at or adjacent a top end of the thermal roller door blade to a location at or adjacent a bottom end of the thermal roller door blade, wherein the spacer strips are made of a second type of flexible filler material and the second type of flexible filler material has a hardness that is greater than the first type of flexible filler material.

Preferably the first type of flexible filler material is an air cell type of thermal insulating material, for example a foil coated air cell insulation material, a polyester bubble foil insulation material, or a thermal aluminium bubble foil material.

Preferably the second type of flexible filler material is a closed cell foamed elastomeric material, for example a foamed ethylene propylene diene monomer (EPDM) elastomeric material or similar product.

In a sixth aspect, the invention may broadly be said to consist in a thermal barrier roller door assembly incorporating at least one thermal roller door blade substantially as specified herein.

Preferably the thermal barrier roller door assembly includes a left door blade edge guide and a right door blade edge guide, each being configured to engage with and guide the left edge and the right edge respectively of the thermal roller door blade panels.

Preferably the thermal barrier roller door assembly includes a roller upon which the thermal roller door blade is wound when the thermal roller door blade is retracted out of a doorway.

Preferably the thermal barrier roller door assembly includes a motor configured to drive the roller.

In a seventh aspect, the invention may broadly be said to consist in a building incorporating at least one thermal barrier roller door assembly substantially as specified herein.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

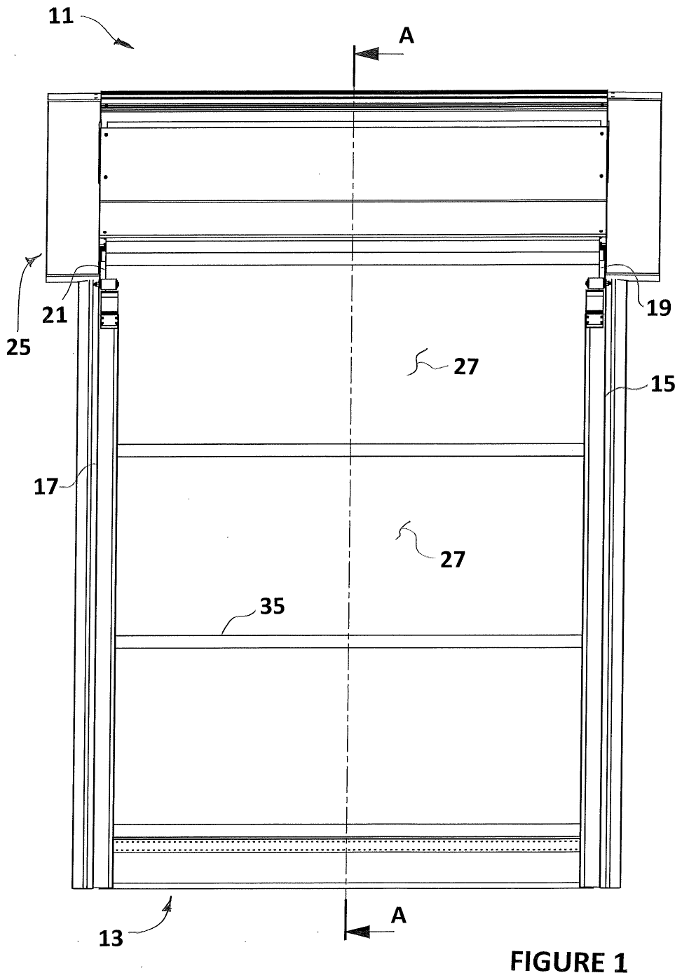

FIG. 1 is a rear elevation view of a first example of a thermal barrier roller door assembly according to the present invention,

FIG. 2 is a cross sectional view A-A of the thermal barrier roller door assembly, as defined in FIG. 1,

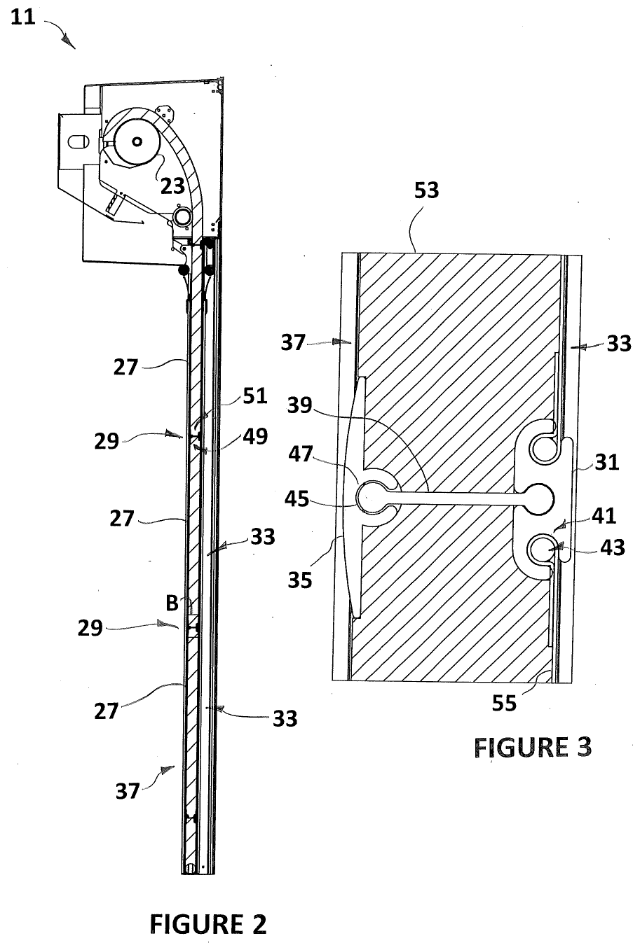

FIG. 3 is an exploded view B as defined in FIG. 2, showing a first example of a joint fitting in a door blade of the thermal barrier roller door assembly,

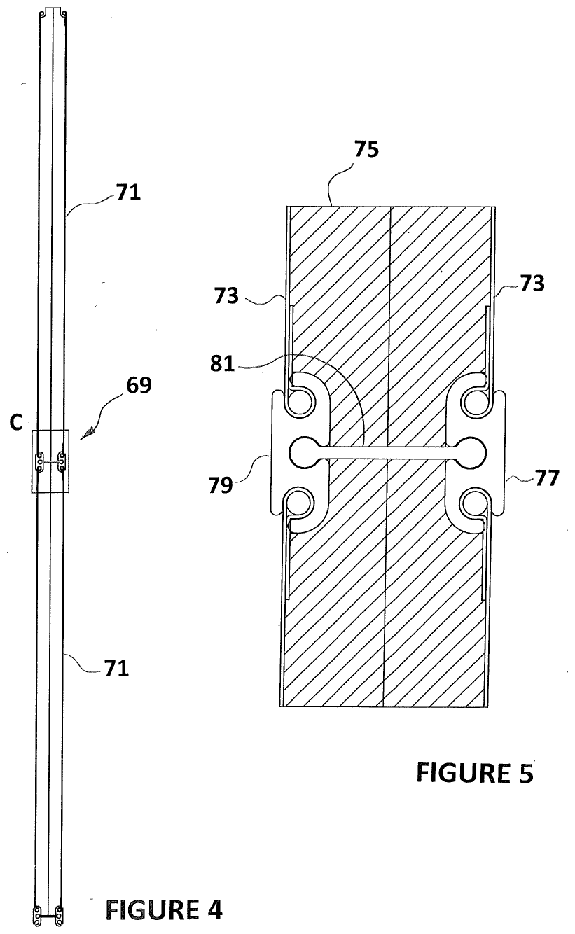

FIG. 4 is a cross sectional view of a second example of a door blade of the thermal barrier roller door assembly according to the present invention,

FIG. 5 is an exploded view C as defined in FIG. 4, showing a second example of a joint fitting situated within the second example of a door blade,

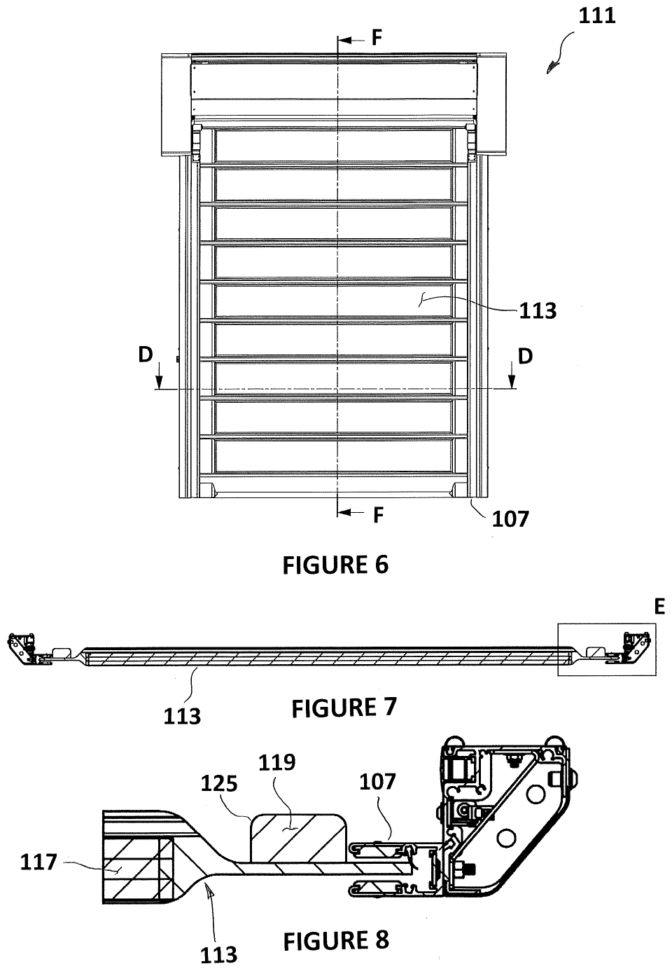

FIG. 6 is a rear elevation view of a third example of a thermal barrier roller door assembly according to the present invention,

FIG. 7 is a cross sectional view D-D of the thermal barrier roller door assembly, as defined in FIG. 6,

FIG. 8 is an exploded view E as defined in FIG. 7, showing a spacer strip fitted to a door blade of the third example of a thermal barrier roller door assembly,

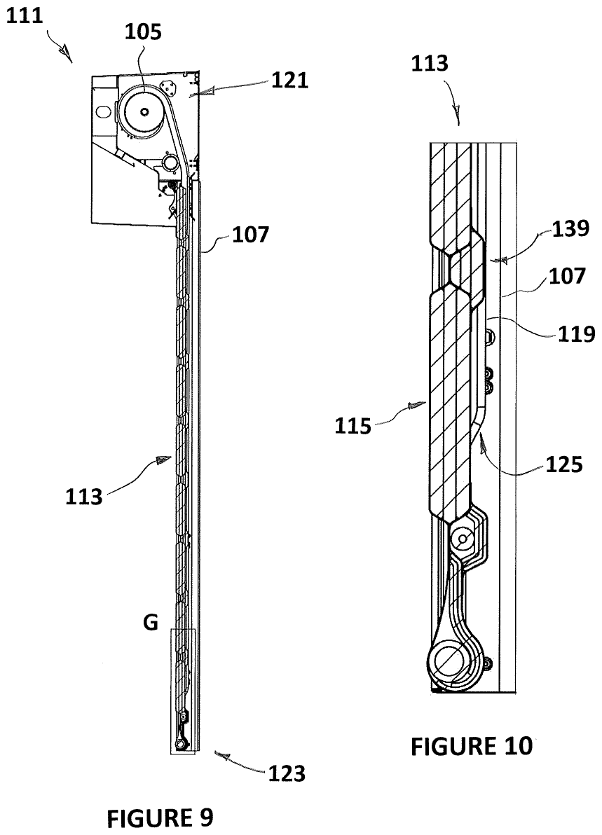

FIG. 9 is a cross sectional view F-F of the third example a thermal barrier roller door assembly,

FIG. 10 is an exploded view G as defined in FIG. 9, showing a section of the door blade of the thermal barrier roller door assembly,

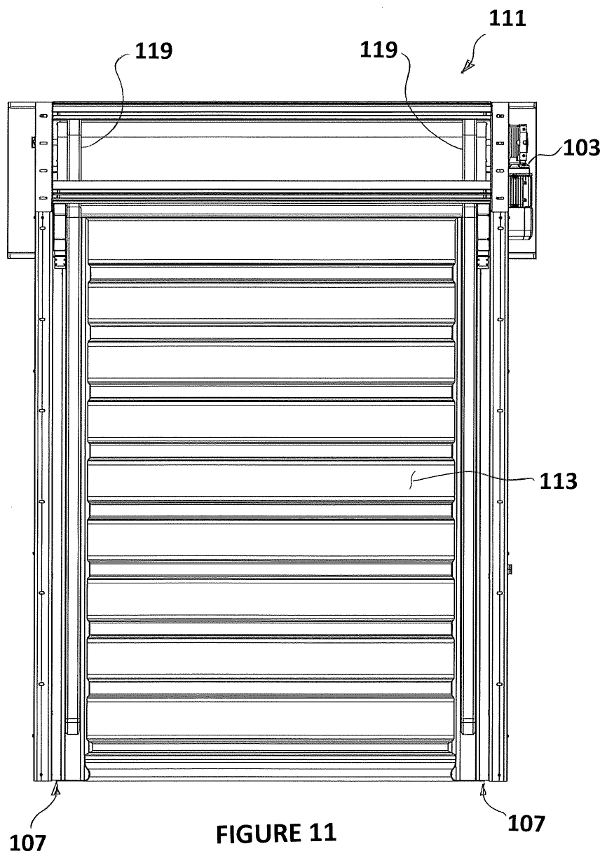

FIG. 11 is front elevation view of the third example of a thermal barrier roller door assembly,

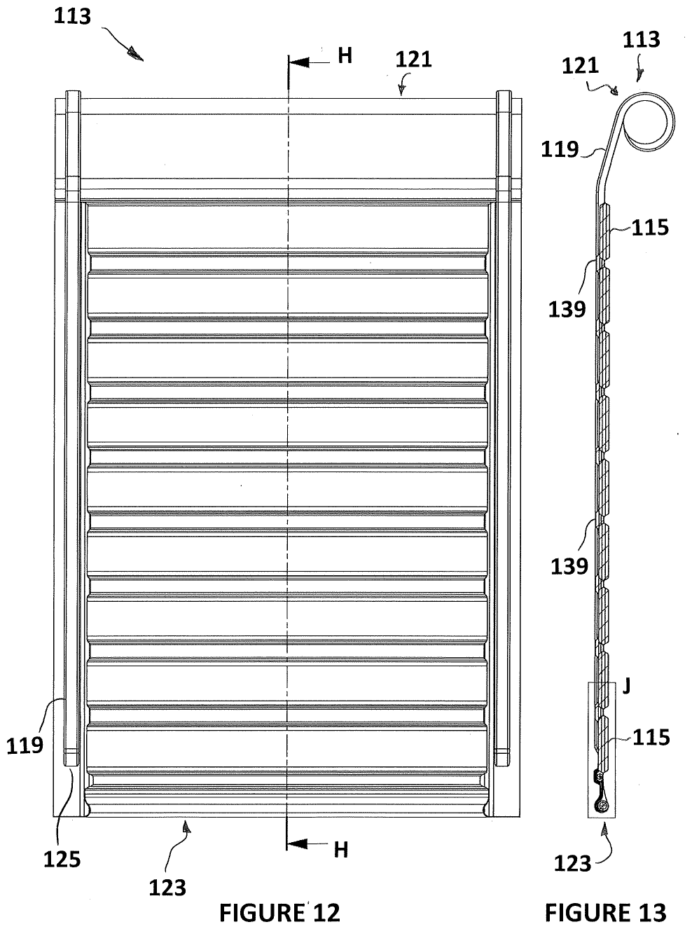

FIG. 12 is a front elevation view of the door blade of the third example of a thermal barrier roller door assembly,

FIG. 13 is a cross sectional view H-H of the door blade, as defined in FIG. 12,

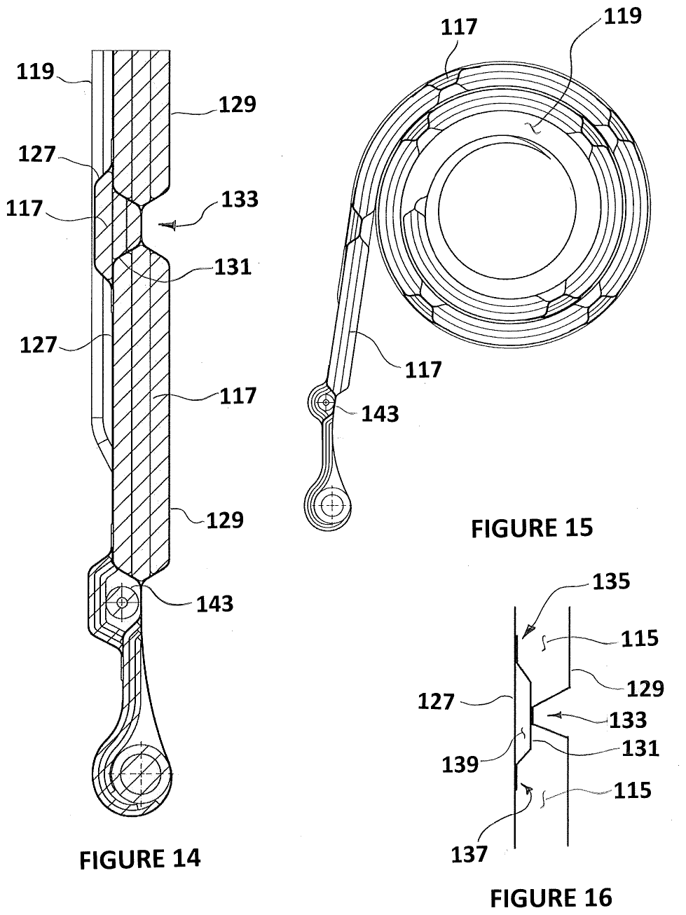

FIG. 14 is an exploded view J as defined in FIG. 13, showing a bottom end of the door blade of the third example of a thermal barrier roller door assembly,

FIG. 15 is a side elevation view of the door blade of the third example a thermal barrier roller door assembly as see when rolled around a roller, and

FIG. 16 is a schematic cross sectional view of a section of the fabric material used to construct the thermal roller door blade shown in FIGS. 6 to 15.

### FIRST EXAMPLE

With reference to FIGS. 1 to 3, a first example of a thermal barrier roller door assembly (11) according to the present invention will now be described. The thermal barrier roller door assembly (11) has been designed for use in buildings such as cool-stores. In such buildings vehicles, for example forklift vehicles, regularly move into and out of a temperature controlled environment, and often at a reasonable speed. In these situations the roller doors are required to open and close rapidly, but also in a safe and a relatively quiet fashion. They also need to be relatively easy to repair as collisions between vehicles and the doors are not uncommon.

The thermal barrier roller door assembly (11) has a thermal roller door blade (13), and a left door blade edge guide (15) and a right door blade edge guide (17). The edge guides (15) and (17) are configured to engage with a left edge (19) and a right edge (21) respectively of the thermal roller door blade (13), and to guide the door blade (13) as it moves up and down, and to hold the door blade (13) in place and steady when in the down, or closed position.

The thermal barrier roller door assembly (11) includes a roller (23) upon which the thermal roller door blade (13) is wound when the thermal roller door blade (13) is retracted up and out of a doorway. The thermal barrier roller door assembly (11) also includes a motor (25) that is configured to drive the roller (23) and thereby to lift or lower the door blade (13).

The thermal roller door blade (13) consists of a number of horizontally aligned thermal door blade panels (27), with adjacent thermal door blade panels (27) being connected or joined by joint fittings or thermal joint fittings (29).

In this example, the joint fittings are thermal joint fittings (29), and each thermal joint fitting (29) comprises three longitudinal members. A first longitudinal member (31) of the three longitudinal members is configured to substantially align with a first or outer face (33) of a thermal roller door blade (13). A second longitudinal member (35) is configured to substantially align with a second and opposite face (37) of the thermal roller door blade (13). And a third longitudinal member (39) is configured to span between the first longitudinal member (31) and the second longitudinal member (35) and to tie the first longitudinal member (31) to the second longitudinal member (35).

When assembled, the three longitudinal members form a beam that has reasonable strength and which is capable of stiffening the door blade (13). The beam ensures that door blade (13) does not flex unduly when struck by gusts of wind or when pushed by light loads.

It can be seen in FIG. 3 that the thermal joint fittings (29) each have two thermal breaks, that is two joints between adjacent longitudinal members. These joints provide thermal breaks and help to minimise heat transfer from the first, or outer surface (33) of the thermal roller door blade to the second, or inner surface (37). The joints between adjacent longitudinal members comprise bulbed edges that are formed on each opposing edge of the of third longitudinal member (39) and which are sized to fit relatively snugly within complimentary bulbed sockets formed in the profile of the first longitudinal member (31) and of the second longitudinal member (35).

Each thermal joint fitting (29) is configured to engage with two thermal door blade panels (27) and to provide a joint between them. In this example, the first longitudinal members (31) include female keder style bulbed sockets (41) that are configured to mate with a bulbed or male keder style edge (43) on the thermal door blade panels (27).

The longitudinal members (31), (35) and (39) are made from a fibre reinforced composite material, for example a fibreglass material. The second longitudinal member (35) includes two bulbed edges (45) that are each configured to engage longitudinally with complimentary bulbed longitudinal sockets formed within the first and the third longitudinal members (31) and (39). The material and the “H” shaped cross section gives the thermal joint fittings (29) a degree of rigidity, but also toughness, suitable for their role both as joiners, but also as wind bars that need to withstand forces created by wind pressures as well as from accidental collisions from fork lift trucks, etc.

Each of the thermal door blade panels (27) is a substantially rectangular panel and having an upper edge (49) and a lower edge (51). The thermal door blade panels (27) have a composite construction and are made of at least one thermal insulating member (53) that is bonded to at least one tensile load carrying panel (55). It can be seen that in this example, the tensile load carrying panels (55) that make up the door blade (13) are configured to engage with a joint fitting (29) along either the upper edge (49) or the lower edge (51), or both edges, of each thermal door blade panel (27).

The tensile load carrying panels (55) are made of a flexible planar sheet material, and ideally a fabric sheet material or a coated fabric sheet material, for example a PVC coated polyester fabric sheet material. At least the upper edge (49) or the lower edge (51), or both, of each tensile load carrying panel (55) includes a bulbed edge (43), or keder style bulbed edge, configured to engage with the keder style sockets (41) of the joint fitting (29). The bulbed edges (43) are formed by wrapping an upper or lower edge of the tensile load carrying panels (55) around a circular former, for example a length of plastic rod or rope. The free edge of the tensile load carrying panel (55) is then attached to the body of the tensile load carrying panel (55) to hold the circular former in place, for example by welding, gluing or sewing.

In this way, each tensile load carrying panel (55) is connected to each associated joint fitting (29) using keder style connections. And because of these connections, the full weight of the part of the door blade (13) that is below each joint fitting (29) is carried by the tensile load carrying panels (55) above the joint fitting (29), right up to the connection of the door blade (13) to the roller (23). This eliminates the need for any tensile loads to be carried via the thermal insulating members, or via any bonds between the thermal insulating members and any intermediary joint fittings.

The thermal insulating members (53) are made of a flexible foamed plastics material, for example a flexible, closed cell, cross-linked polyolefin foam, or an acrylonitrile butadiene rubber foam. Ideally the thermal insulating members (53) are approximately fifty millimetres thick, and can be made of one layer or multiple layers of foamed material. Ideally, if multiple layers are used, the layers should be bonded or glued together. The thermal insulating members (53) can be bonded to the tensile load carrying panels (55) using adhesive, or Velcro joints, etc.

Each of the thermal door blade panels (27) includes a left edge (19) and a right edge (21), the left edge (19) and the right edge (21) both being configured to engage with, and slide up and down the roller door blade edge guides (15) and (17).

As noted above, each joint fitting (29) has an “H” cross section. This allows the bottom edge of one thermal insulating member (53) to be inserted into the lower half of the “H” section, and a top edge of another thermal insulating member (53) to be inserted into the upper half of the “H” section. In this way, each thermal insulating member (53) is held snugly between adjacent joint fittings (29).

This allows easy replacement of door blade panels. A single thermal door blade panel (27) can be replaced by sliding it out of its connection to the joint fittings (29) above and below the panel (27). The thermal insulating member (53) of the door blade panel (27) can slide out of the “H” section of the joint fitting (29) at the same time as the keder edges of the tensile load carrying panel (55) of the door blade panel (27) slides out of the bulbed sockets (47) of the joint fitting (29).

Similarly, individual wind bars, or individual longitudinal members can be replaced with ease also by simply sliding the old parts out and sliding replacement parts in.

The first longitudinal member (31) and the second longitudinal member (35) also both act as capping strips to conceal the join between adjacent thermal insulating members (53).

The keder style joints between the tensile load carrying panels (55) and the first longitudinal members (31), and between the first, second and third longitudinal members (31), (35) and (39) allow a degree of flexibility or pivoting at each joint which is considered advantageous when the door blade (13) is being rolled onto the roller (23) as it allows flexing and movement which reduces stresses in the affected components and ensures a longer operational life of the door blade (13).

### SECOND EXAMPLE

With reference to FIGS. 4 and 5, a second example of a joint fitting (69) will now be described. In this example, each thermal door blade panel (71) has a tensile load carrying panel (73) on both sides of a thermal insulating member (75). Also the thermal insulating member (75) is shown as being made up of two twenty five millimetre thick sheets of foamed material that have been bonded together to make a fifty millimetre thick panel.

In this second example (69) a first longitudinal member (77) is a mirror image of a second longitudinal member (79). In this way, both tensile load carrying panels (73) of each thermal door blade panel (71) can be connected to the longitudinal members (77) and (79), using keder style connections, allowing both sides of the thermal door blade panel (71) to carry tensile loads. The first and second longitudinal members (77) and (79) are by a third longitudinal member (81) in a similar fashion to the construction of the first thermal joint fitting (29).

In all other respects the second example of a joint fitting (69) is essentially the same as the first example of a thermal barrier roller door assembly (11). For example, the first and second longitudinal members (77) and (79) are each joined to a third longitudinal member (81) in a similar fashion to the construction of the first thermal joint fitting (29).

### THIRD EXAMPLE

With reference to FIGS. 6 to 16, a third example of a thermal barrier roller door assembly (111) according to the present invention will now be described. The thermal barrier roller door assembly (111) has been designed for the same use as the first and second examples described above. The general features of a drive mechanism (103), roller (105) and guides (107) are the same as those of the first and second examples described above. It is primarily the construction of the roller door blade that is different.

In this third example the thermal barrier roller door assembly (111) has a thermal roller door blade (113) comprising a number of horizontally aligned first pockets (115) that each contain a flexible thermal insulating material (117). The outer surfaces of the thermal roller door blade (113) are made of a flexible planar sheet material, for example a PVC coated fabric material. The first pockets (115) are formed primarily between two layers of the PVC coated fabric material. The layers of the PVC coated fabric material are welded together to form the pockets that hold the flexible thermal insulating material (117). The first pockets (115) are elongate rectangular pockets and are aligned in a substantially transverse direction, spanning across the greater part of the width of the thermal roller door blade (113).

Importantly, the thermal roller door blade (113) also has two spacer strips (119). The spacer strips (119) are each oriented in a substantially longitudinal or vertical direction and each extends from a location adjacent a top end (121) of the thermal roller door blade (113) to a location adjacent a bottom end (123) of the thermal roller door blade (113).

The spacer strips (119) are situated adjacent to the left and the right edges of the door blade (113) and are positioned adjacent to each end of the first pocket (115). The spacer strips (119) have a thickness that is substantially the same as, or a little thicker than, a mean thickness of the flexible thermal insulating material (117) contained within the first pockets (115). Ideally the spacer strips (119) have a thickness that is in the range of five to fifteen percent greater than the mean thickness of the flexible thermal insulating material (117) in the first pockets (115).

The spacer strips (119) are made from a foamed elastomeric material, for example a foamed ethylene propylene diene monomer (EPDM) elastomeric material. Ideally the material that forms the spacer strips (119) has a hardness rating that is greater than a hardness rating of the flexible thermal insulating material (117). In this example, the material that forms the spacer strips (119) has a Shore C Hardness in the range of seventeen to twenty five, but it is envisaged that a Shore C Hardness in the range of fifteen to thirty would be suitable. Such a material has good thermal insulating characteristics, and is not as prone to crushing as the flexible thermal insulating material (117), and being in strip form is still relatively easily rolled up even when cold soaked from a freezer room.

The spacer strips (119) are contained within second pockets (125) of the thermal roller door blade (113). The second pockets (125) are elongate pockets aligned in the substantially longitudinal or vertical direction, and can be made of the same flexible planar sheet material that is used to make the outer surfaces of the door blade (113). The spacer strips (119) are covered in a low friction sleeve, for example a sleeve made of a lycra or silk fabric or a similar low friction material. Alternatively, the second pockets (125) could include a low friction lining. The low friction material helps the spacer strips (119) to move within the second pockets (125) as required each time the thermal roller door blade (113) is rolled up or is extended. For example, the spacer strips (119) may tend to elongate slightly during each door retraction, or at least to reposition themselves downwards a little relative to the material that forms the second pockets (125).

The flexible thermal insulating material (117) comprises a number of layers of an insulating material in the form of air cell insulation material. The air cell insulation material is in the form of foil coated or foil-faced air cell insulation sheets. This type of material is sometimes referred to as a polyester bubble foil insulation material, or a thermal aluminium bubble foil material.

With reference to FIG. 16 it can be seen that the construction of the thermal roller door blade (113) includes an outer layer (127) and an inner layer (129) that form the outer surfaces, and a number of transversely extending intermediate strips (131). The inner layer (129) is the layer that is innermost, or which lies against the roller drum (105) when the thermal roller door blade (113) is retracted or rolled up, or placed in a door open configuration as shown in FIG. 15. The outer layer (127) is the primary load carrying layer during the retraction process.

The outer layer (127), the inner layer (129) and the intermediate strips (131) are all made of a flexible planar sheet material, which in this example is a PVC coated fabric material as noted above. The construction of the thermal roller door blade (113) includes transverse lines of attachment between the outer layer (127) and the intermediate strips (131), and between the inner layer (129) and the intermediate strips (131). In this example the transverse lines of attachment are in the form of welds.

The intermediate strips (131) run transversely across the thermal roller door blade (113). The intermediate strips (131) are situated at, and they overly, a series of abutment zones (133). The abutment zones (133) are situated between each adjacent pairing of first pockets (115). An upper edge (135) of each intermediate strip (131) is attached to the outer layer (127) a short distance above its associated abutment zone (133), and a bottom edge (137) of each intermediate layer strip (131) is attached to the outer layer (127) a short distance below its associated abutment zone (133). The spaces formed between the outer layer (127) and each of the intermediate strips (131) form a series of third pockets (139).

The inner layer (129) is attached to each of the intermediate strips (131) along a transverse line of attachment that is situated between the top edge (135) and the bottom edge (137) of the respective intermediate layer strip (131). The transverse lines of attachment between the inner layer (129) and each of the intermediate strips (131) each define a top edge of the first pocket (115) that is situated directly below each transverse line of attachment, and/or define a bottom edge of the first pocket (115) that is situated directly above each transverse line of attachment.

Layers of the flexible thermal insulating material (117) are also contained within each of the third pockets (139). The third pockets (139) are aligned in a substantially transverse direction on the thermal roller door blade (113), and the third pockets (139) overlie the abutment zones (133) between each of the first pockets (115). The abutment zones (133) include gaps between the flexible thermal insulating material (117) that is contained within each of the first pockets (115). In this way the flexible thermal insulating material (117) contained within each of the third pockets (139) provides thermal insulation at the abutment zones (133).

The second pockets (125) are also formed using strips of the flexible planar sheet material, or the PVC coated fabric material, that are welded or otherwise bonded along the left and right hand edges of the outer layer (127) to form elongate pockets along the length of the door blade (113) to accommodate the spacer strips (119).

In this example, the thermal roller door blade (113) includes a wind bar (143) that is situated within the lowest of the third pockets (139)—refer to FIG. 14. It is envisaged that additional wind bars (143) could be included in one or more of the other third pockets (139), or alternatively within one or more of the first pockets (115), for example at the bottom of some of the first pockets (115).

A success of the third example of a thermal barrier roller door assembly (111) comes from the fact that the thermal roller door blade (113) uses a softer first type of flexible filler material as the primary insulation material and a slightly firmer or harder second type of flexible filler material that acts primarily as spacer elements but which also contribute to the thermal insulation of the door blade (113). This gives a door assembly (111) that provides excellent thermal insulating qualities while still being able to roll up efficiently when cold soaked, and which is relatively dimensionally stable even over a range of operating environments where the difference in the temperatures on either side of the door blade (113) is significant.

### Variations

Aspects of the present invention have been described by way of example only and it should be appreciated that modifications and additions may be made thereto without departing from the scope thereof.

In the examples described above, the thermal joint fittings (29) comprise three parts, giving two thermal breaks. However it is envisaged that other configurations that provide just a single thermal break (i.e. using just two longitudinal members), or more than two thermal breaks (i.e. by using more than three longitudinal members) are feasible.

It is also envisaged that the use of the joint fittings (29) could be eliminated by connecting each thermal door blade panel directly to an adjacent thermal door blade panel. For example, by having a male keder fitting situated along the upper edge of each thermal door blade panel, the male keder fitting being configured to engage with a female keder connection situated along the lower edge of each thermal door blade panel.

The thermal insulating members (53) can alternatively be made of foamed polyurethane material, or a foamed polyethylene material or any other suitable flexible foamed plastics material.

In a further variation, it is envisaged that the tensile load carrying panel could be a continuous panel extending from the top of the door blade to the bottom, with keder connections bonded to it at regular intervals to allow connections to the longitudinal members (31), for example. In this way, the longitudinal members could still be attached and could act as wind bars, and as caps to cover joints between adjacent thermal insulating members, but not act as joint fittings.

In the examples described herein a PVC coated fabric material is used in the construction of the door blades. However, it is envisaged that alternative flexible planar sheet materials could be used, for example many other fabric materials, particularly water resistant fabric materials, could be used.

The door blade in the third example described herein includes two spacer strips. It is envisaged that the door blade could include more spacer strips, for example a third spacer strip down the centre of the door blade.

### Definitions

Throughout this specification the word “comprise” and variations of that word, such as “comprises” and “comprising”, are not intended to exclude other additives, components, integers or steps.

### Advantages

Thus it can be seen that the invention provides a number of thermal barrier roller door assembly configurations that potentially have the following advantages;
improved durability due to reduced likelihood of failure at joints between adjacent thermal panels,
improved tensile load carrying path between adjacent thermal panels,
improved flexibility of the joints between adjacent thermal panels,
improved thermal insulation at the joints between adjacent thermal panels,
ease of replacement of individual thermal panels or wind bars,
the method of construction allows thicker thermal insulation to be used without compromising the structural integrity of the door blades,
improved thermal insulating properties as a result of the thicker insulation, and
improved dimensional stability.

1. A thermal roller door blade for a roller door assembly, the thermal roller door blade having a plurality of first pockets containing a flexible thermal insulating material, the first pockets being formed between two or more layers of a flexible planar sheet material, the thermal roller door blade also having two or more spacer strips, the spacer strips each being oriented in a substantially longitudinal direction and extending from a location at or adjacent a top end of the thermal roller door blade to a location at or adjacent a bottom end of the thermal roller door blade.

2. The thermal roller door blade as claimed in claim 1, wherein the first pockets are aligned in a substantially transverse direction on the thermal roller door blade.

3. The thermal roller door blade as claimed in claim 2, wherein the spacer strips are situated at or adjacent each end of each first pocket.

4. The thermal roller door blade as claimed in claim 1, wherein the spacer strips have a thickness that is substantially the same as, or thicker than, a mean thickness of the flexible thermal insulating material contained within the first pockets.

5. The thermal roller door blade as claimed in claim 1, wherein the spacer strips have a thickness that is in the range of five to fifteen percent greater than the mean thickness of the flexible thermal insulating material contained within the first pockets.

6. The thermal roller door blade as claimed in claim 1, wherein the material that forms the spacer strips has a hardness rating that is greater than a hardness rating of the flexible thermal insulating material.

7. The thermal roller door blade as claimed in claim 1, wherein the material that forms the spacer strips has a Shore C Hardness in the range of fifteen to thirty.

8. The thermal roller door blade as claimed in claim 1, wherein the material that forms the spacer strips has a Shore C Hardness in the range of seventeen to twenty five.

9. The thermal roller door blade as claimed in claim 1, wherein the spacer strips are contained within second pockets of the thermal roller door blade.

10. The thermal roller door blade as claimed in claim 9, wherein the spacer strips are covered in a low friction sleeve or the second pockets include a low friction lining material.

11. The thermal roller door blade as claimed in claim 1, wherein the flexible thermal insulating material includes one or more layers of insulating material in the form of air cell insulation material.

12. The thermal roller door blade as claimed in claim 1, wherein the thermal roller door blade includes an outer layer of the flexible planar sheet material and an inner layer of the flexible planar sheet material.

13. The thermal roller door blade as claimed in claim 12, wherein the thermal roller door blade includes an abutment zone between each adjacent pairing of first pockets, and the thermal roller door blade includes an intermediate strip of flexible planar sheet material that is situated at or adjacent each abutment zone.

14. The thermal roller door blade as claimed in claim 13, wherein the construction of the thermal roller door blade includes transverse lines of attachment between the outer layer of the flexible planar sheet material, the intermediate strips of the flexible planar sheet material, and the inner layer of the flexible planar sheet material.

15. The thermal roller door blade as claimed in claim 13, wherein each intermediate strip that is attached to the outer layer along a top edge of the intermediate strip and is attached to the outer layer along a bottom edge of the intermediate strip.

16. The thermal roller door blade as claimed in claim 13, wherein the inner layer is attached to each of the intermediate layer strips along a line of attachment that is situated between the top edge of the respective intermediate strip and the bottom edge of the respective intermediate strip.

17. The thermal roller door blade as claimed in claim 16, wherein each line of attachment between the inner layer and each of the intermediate strips defines the top of the first pocket that is situated directly below the respective line of attachment, and/or defines the bottom of the first pocket that is situated directly above the respective line of attachment.

18. The thermal roller door blade as claimed in claim 14 wherein the spaces formed between the outer layer and each of the intermediate strips each form a third pocket.

19. The thermal roller door blade as claimed in claim 18, wherein the flexible thermal insulating material is also contained within each of the third pockets.

20. A thermal barrier roller door assembly incorporating at least one thermal roller door blade as claimed in claim 1.
